(19) United States
(12) Patent Application Publication
(10) Pub. No.: US 2015/0026358 A1
(43) Pub. Date: Jan. 22, 2015

(54) Metadata Information Signaling And Carriage In Dynamic Adaptive Streaming Over Hypertext Transfer Protocol

(71) Applicant: Futurewei Technologies, Inc., Plano, TX (US)

(72) Inventors: Shaobo Zhang, Shenzhen (CN); Xin Wang, Rancho Palos Verdes, CA (US)

(21) Appl. No.: 14/335,519

(22) Filed: Jul. 18, 2014

Related U.S. Application Data
(60) Provisional application No. 61/856,532, filed on Jul. 19, 2013.

(51) Int. Cl. H04L 29/06

(52) U.S. Cl. CPC H04L 65/601
USPC 709/231

(57) ABSTRACT

A computer program product that when executed by a processor causes a network device to obtain a media presentation description (MPD) that comprises instructions for retrieving one or more segments from a plurality of adaptation sets, sending a first segment request for one or more segments from a first adaptation set in accordance with the instructions provided in the MPD, receiving the segment from the first adaptation set, selecting one or more segments from a second adaptation set based on the one or more segments from the first adaptation set, sending a second segment request that requests the one or more segments from the second adaptation set, and receiving the one or more segments from the second adaptation set in response to the second segment request, wherein the first adaptation set comprises timed metadata information, and wherein the second adaptation set comprises media content.

### CROSS-REFERENCE TO RELATED APPLICATIONS

The present application claims benefit of U.S. Provisional Patent Application No. 61/856,532 filed Jul. 19, 2013 by Shaobo Zhang, et al. and entitled, “Signaling and Carriage of Quality Information of Streaming Content,” which is incorporated herein by reference as if reproduced in its entirety.

### STATEMENT REGARDING FEDERALLY SPONSORED RESEARCH OR DEVELOPMENT

Not applicable.

### REFERENCE TO A MICROFICHE APPENDIX

Not applicable.

### BACKGROUND

A media content provider or distributor may deliver various media content to subscribers or users using different encryption and/or coding schemes suited for different devices (e.g., televisions, notebook computers, desktop computers, and mobile handsets). Dynamic adaptive streaming over hypertext transfer protocol (HTTP) (DASH) defines a manifest format, media presentation description (MPD), and segment formats for International Organization for Standardization (ISO) Base Media File Format (ISO-BMFF) and Moving Picture Expert Group (MPEG) Transport Stream under the family of standards MPEG-2, as described in ISO/International Electrotechnical Commission (IEC) 13818-1, titled “Information Technology—Generic Coding of Moving Pictures and Associated Audio Information: Systems.” A DASH system may be implemented in accordance with the DASH standard described in International Organization for Standardization (ISO)/International Electrotechnical Commission (IEC) 23009-1, entitled, “Information Technology—Dynamic Adaptive Streaming over HTTP (DASH)—part 1: Media Presentation Description and Segment Formats.”

A conventional DASH system, may require multiple bitrate alternatives of media content or representations to be available on a server. The alternative representations may be encoded versions in constant bitrate (CBR) or variable bitrate (VBR). For CBR representations, the bitrate may be controlled and may be about constant, but the quality may fluctuate significantly unless the bitrate is sufficiently high. Changing content, such as switching sports/static scenes in news channels may be difficult for video encoders to deliver consistent quality while producing a bitstream that has a certain specified bitrate. For VBR representations, higher bitrates may be allocated to the more complex scenes while fewer bits may be allocated to less complex scenes. When using unconstrained VBR representations, the quality of the encoded content may not be constant and/or there may be one or more limitations (e.g., a maximum bandwidth). Quality fluctuation may be inherent in content encoding and may not be specific to DASH applications.

Additionally, the available bandwidth may be constantly changing, which may be a challenge for streaming media content. Conventional adaptation schemes may be configured to adapt to a device's capabilities (e.g., decoding capability or display resolution) or a user's preference (e.g., language or subtitle). In a conventional DASH system, an adaptation to the changing available bandwidth may be enabled by switching between alternative representations having different bitrates. The bitrates of representations or segments may be matched to the available bandwidth. However, the bitrate of a representation may not directly correlate to the quality of the media content. Bitrates of multiple representations may express the relative qualities of these representations and may not provide information about the quality of a segment in a representation. For example, a high quality level can be encoded with low bitrate for scenes (e.g., low spatial complexity or low motion level) or a low quality level can be encoded with high bitrate scenes, for the same bitrate. Thus, bandwidth fluctuations cause a relatively low quality of experience for the same bitrate. Bandwidth may also be wasted when a relatively high bandwidth is unused or not needed. Aggressive bandwidth consumption may also result in limiting the number of users that can be supported, high bandwidth spending, and/or high power consumption.

### SUMMARY

In one embodiment, the disclosure includes a media representation adaptation method, comprising obtaining a media presentation description (MPD) that comprises information for retrieving a plurality of media segments and a plurality of metadata segments associated with the plurality of media segments, wherein the plurality of metadata segments comprises timed metadata information associated with the plurality of media segments, sending a metadata segment request for one or more of the metadata segments in accordance with the information provided in the MPD, receiving the one or more metadata segments, selecting one or more media segments based on the timed metadata information of the one or more metadata segments, sending a media segment request that requests the selected media segments, and receiving the selected media segments in response to the media segment request.

In another embodiment, the disclosure includes a computer program product comprising computer executable instructions stored on a non-transitory computer readable medium that when executed by a processor causes a network device to obtain an MPD that comprises information for retrieving one or more segments from a plurality of adaptation sets, send a first segment request for one or more segments from a first adaptation set in accordance with the information provided in the MPD, wherein the first adaptation set comprises timed metadata information associated with a plurality of segments in a second adaptation set, receive the segment from the first adaptation set, select one or more segments from the plurality of segments in the second adaptation set based on the one or more segments from the first adaptation set, wherein the one or more selected segments from the plurality of segments in the second adaptation set comprises media content, send a second segment request that requests the one or more segments from the second adaptation set, and receive the one or more selected segments from the second adaptation set in response to the second segment request.

In yet another embodiment, the disclosure includes an apparatus for media representation adaptation according to an MPD that comprises information for retrieving a plurality of media segments from a first adaptation set and a plurality of metadata segments from a second adaptation set, comprising a memory, and a processor coupled to the memory, wherein the memory includes instructions that when executed by the processor cause the apparatus to send a metadata segment request in accordance with the MPD, receive one or more metadata segments that comprises timed metadata information associated with one or more of the media segments, select one or more media segments using the metadata information, send a media segment request that requests the one or more media segment, and receive the one or more media segment in accordance with the MPD.

These and other features will be more clearly understood from the following detailed description taken in conjunction with the accompanying drawings and claims.

### BRIEF DESCRIPTION OF THE DRAWINGS

For a more complete understanding of this disclosure, reference is now made to the following brief description, taken in connection with the accompanying drawings and detailed description, wherein like reference numerals represent like parts.

FIG. 1 is a schematic diagram of an embodiment of a dynamic adaptive streaming over hypertext transfer protocol (HTTP) (DASH) system.

FIG. 2 is a schematic diagram of an embodiment of a network element.

FIG. 3 is a protocol diagram of an embodiment of a DASH adaptation method.

FIG. 4 is a schematic diagram of an embodiment of a media presentation description.

FIG. 5 is a schematic diagram of an embodiment of a sample level metadata association.

FIG. 6 is a schematic diagram of an embodiment of a track run level metadata association.

FIG. 7 is a schematic diagram of an embodiment of a track fragment level metadata association.

FIG. 8 is a schematic diagram of an embodiment of a movie fragment level metadata association.

FIG. 9 is a schematic diagram of an embodiment of a sub-segment level metadata association.

FIG. 10 is a schematic diagram of an embodiment of a media segment level metadata association.

FIG. 11 is a schematic diagram of an embodiment of an adaptation set level metadata association.

FIG. 12 is a schematic diagram of an embodiment of a media sub-segment level metadata association.

FIG. 13 is a flowchart of an embodiment of a representation adaptation method used by a DASH client.

FIG. 14 is a flowchart of an embodiment of a representation adaptation method using metadata information.

FIG. 15 is a flowchart of another embodiment of a representation adaptation method using metadata information.

FIG. 16 is a flowchart of another embodiment of a representation adaptation method used by a server.

### DETAILED DESCRIPTION

It should be understood at the outset that although an illustrative implementation of one or more embodiments are provided below, the disclosed systems and/or methods may be implemented using any number of techniques, whether currently known or in existence. The disclosure should in no way be limited to the illustrative implementations, drawings, and techniques illustrated below, including the exemplary designs and implementations illustrated and described herein, but may be modified within the scope of the appended claims along with their full scope of equivalents.

Disclosed herein are various embodiments for communicating and signaling metadata information (e.g., quality information) for media content in a dynamic adaptive streaming over hypertext transfer protocol (HTTP) (DASH) system. In particular, an association between a plurality of representations may be employed to communicate and/or signal metadata information for representation adaptations in a DASH system. An association between a plurality of representations may be implemented on a representation level and/or on an adaptation set level. For instance, an association may be between a first representation corresponding to media content and a second representation corresponding to metadata information. An adaptation set that comprises metadata information may be referred to as a metadata set. A DASH client may use a metadata set to obtain metadata information associated with an adaptation set that comprises media content and a plurality of media segments to make representation adaptation decisions.

In one embodiment, an adaptation set association may allow metadata information to be communicated using out-of-band signaling and/or for carriage of metadata information using an external index file. The use of out-of-band signaling may reduce the impact that adding, removing, and/or modifying metadata information has on media data. Metadata information may be signaled on a segment or sub-segment level to efficiently support live and/or on-demand services. Metadata information may be retrieved independently before one or more media segments are requested. For instance, metadata information may be available before media content begins streaming. Metadata information may be provided with other access information (e.g., sub-segment size or duration) for media data which may reduce the need for cross-referencing to correlate bitrate information and quality information. An adaptation decision using the metadata information may reduce quality fluctuations of streamed content, may improve the quality of experience, and may use bandwidth more efficiently. Metadata information may be used, modified, and/or generated conditionally and may not impact the operation of streaming media data. The frequency of media presentation description (MPD) updates may also be reduced. Media content and metadata information may be generated at different stages of content preparation and/or may be produced by different people. The use of metadata information may support uniform resource locator (URL) indication and/or generation in both a playlist and a template. Metadata information may not be signaled for each segment in an MPD, which may otherwise inflate the MPD. The metadata information may not have a significant impact on the start-up delay and may consume as little network traffic as possible.

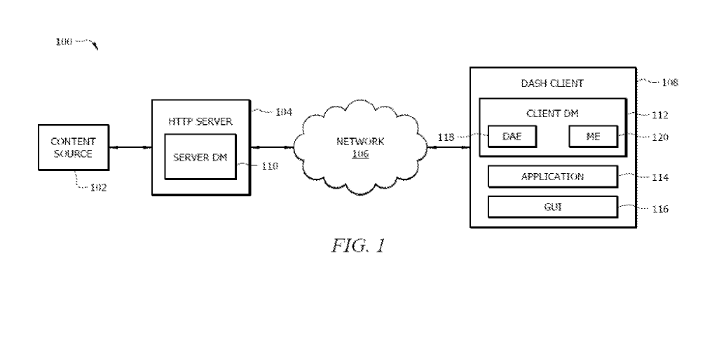

FIG. 1 is a schematic diagram of an embodiment of a DASH system 100 where embodiments of the present disclosure may operate. The DASH system 100 may generally comprise a content source 102, an HTTP Server 104, a network 106, and one or more DASH clients 108. In such an embodiment, the HTTP server 104 and the DASH client 108 may be in data communication with each other via the network 106. Additionally, the HTTP server 104 may be in data communication with the content source 102. Alternatively, the DASH system 100 may further comprise one or more additional content sources 102 and/or HTTP servers 104. The network 106 may comprise any network configured to provide data communication between the HTTP server 104 and the DASH client 108 along wired and/or wireless channels. For example, the network 106 may be an Internet or mobile telephone network. Descriptions of the operations performed by the DASH system 100 may generally refer to instances of one or more DASH clients 108. It is noted that the use of the term DASH throughout the disclosure may include any adaptive streaming, such as HTTP Live Streaming (HLS), Microsoft Smooth Streaming, or Internet Information Services (IIS), and may not be constrained to represent only third generation partnership (3GP)-DASH or moving picture expert group (MPEG)-DASH.

The content source 102 may be a media content provider or distributor which may be configured to deliver various media contents to subscribers or users using different encryption and/or coding schemes suited for different devices (e.g., television, notebook computers, and/or mobile handsets). The content source 102 may be configured to support a plurality of media encoders and/or decoders (e.g., codecs), media players, video frame rates, spatial resolutions, bitrates, video formats, or combinations thereof. Media content may be converted from a source or original presentation to various other representations to suit different users.

The HTTP server 104 may be any network node, for example, a computer server that is configured to communicate with one or more DASH clients 108 via HTTP. The HTTP server 104 may comprise a server DASH module (DM) 110 configured to send and receive data via HTTP. In one embodiment, the HTTP server 104 may be configured to operate in accordance with the DASH standard described in International Organization for Standardization (ISO)/International Electrotechnical Commission (IEC) 23009-1, entitled, “Information Technology—Dynamic Adaptive Streaming over HTTP (DASH)—part 1: Media Presentation Description and Segment Formats,” which is incorporated herein by reference as if reproduced in its entirety. The HTTP server 104 may be configured to store media content (e.g., in a memory or cache) and/or to forward media content segments. Each segment may be encoded in a plurality of bitrates and/or representations. The HTTP server 104 may form a portion of a content delivery network (CDN), which may refer to a distribution system of servers deployed in multiple data centers over multiple backbones for the purpose of delivering content. A CDN may comprise one or more HTTP servers 104. Although FIG. 1 illustrates an HTTP server 104, other DASH servers, such as, origin servers, web servers, and/or any other suitable type of server may store media content.

A DASH client 108 may be any network node, for example, a hardware device that is configured to communicate with the HTTP server 104 via HTTP. A DASH client 108 may be a notebook computer, a tablet computer, a desktop computer, a mobile telephone, or any other device. The DASH client 108 may be configured to parse an MPD to retrieve information regarding the media content, such as timing of the program, availability of media content, media types, resolutions, minimum and/or maximum bandwidths, existence of various encoded alternatives of media components, accessibility features and required digital right management (DRM), location of each media component (e.g., audio data segments and video data segments) on the network, and/or other characteristics of the media content. The DASH client 108 may also be configured to select an appropriate encoded version of the media content according to the information retrieved from the MPD and to stream the media content by fetching media segments located on the HTTP server 104. A media segment may comprise audio and/or visual samples from the media content. A DASH client 108 may comprise a client DM 112, an application 114, and a graphical user interface (GUI) 116. The client DM 112 may be configured to send and receive data via HTTP and a DASH protocol (e.g., ISO/IEC 23009-1). The client DM 112 may comprise a DASH access engine (DAE) 118 and a media output (ME) 120. The DAE 118 may be configured as the primary component for receiving raw data from the HTTP server 104 (e.g., the server DM 110) and constructing the data into a format for viewing. For example, the DAE 118 may format the data in MPEG container formats along with timing data, then output the formatted data to the ME 120. The ME 120 may be responsible for initialization, playback, and other functions associated with content and may output that content to the application 114.

The application 114 may be a web browser or other application with an interface configured to download and present content. The application 114 may be coupled to the GUI 116 so that a user associated with the DASH client 108 may view the various functions of the application 114. In an embodiment, the application 114 may comprise a search bar so that the user may input a string of words to search for content. If the application 114 is a media player, then the application 114 may comprise a search bar so that the user may input a string of words to search for a movie. The application 114 may present a list of search hits, and the user may select the desired content (e.g., a movie) from among the hits. Upon selection, the application 114 may send instructions to the client DM 112 for downloading the content. The client DM 112 may download the content and process the content for outputting to the application 114. For example, the application 114 may provide instructions to the GUI 116 for the GUI 116 to display a progress bar showing the temporal progress of the content. The GUI 116 may be any GUI configured to display functions of the application 114 so that the user may operate the application 114. As described above, the GUI 116 may display the various functions of the application 114 so that the user may select content to download. The GUI 116 may then display the content for viewing by the user.

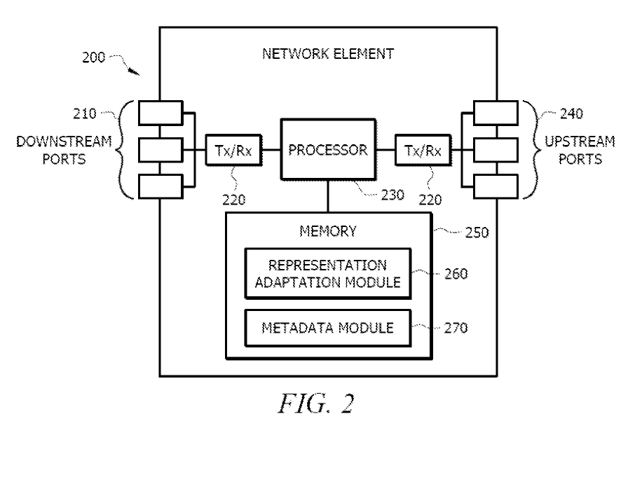

FIG. 2 is a schematic diagram of an embodiment of a network element 200 that may be used to transport and process data traffic through at least a portion of a DASH system 100 shown in FIG. 1. At least some of the features/methods described in the disclosure may be implemented in a network element. For instance, the features/methods of the disclosure may be implemented in hardware, firmware, and/or software installed to run on the hardware. The network element 200 may be any device (e.g., a server, a client, a base station, a user-equipment, a mobile communications device, etc.) that transports data through a network, system, and/or domain. Moreover, the terms network “element,” network “node,” network “device,” network “component,” network “module,” and/or similar terms may be interchangeably used to generally describe a network device and do not have a particular or special meaning unless otherwise specifically stated and/or claimed within the disclosure. In one embodiment, the network element 200 may be an apparatus configured to communicate metadata information within an adaptation set, to implement DASH, and/or to establish and communicate via an HTTP connection. For example, network element 200 may be, or incorporated with, an HTTP server 104 or a DASH client 108 as described in FIG. 1.

The network element 200 may comprise one or more downstream ports 210 coupled to a transceiver (Tx/Rx) 220, which may be transmitters, receivers, or combinations thereof. The Tx/Rx 220 may transmit and/or receive frames from other network nodes via the downstream ports 210. Similarly, the network element 200 may comprise another Tx/Rx 220 coupled to a plurality of upstream ports 240, wherein the Tx/Rx 220 may transmit and/or receive frames from other nodes via the upstream ports 240. The downstream ports 210 and/or the upstream ports 240 may include electrical and/or optical transmitting and/or receiving components. In another embodiment, the network element 200 may comprise one or more antennas coupled to the Tx/Rx 220. The Tx/Rx 220 may transmit and/or receive data (e.g., packets) from other network elements wirelessly via one or more antennas.

A processor 230 may be coupled to the Tx/Rx 220 and may be configured to process the frames and/or determine which nodes to send (e.g., transmit) the packets. In an embodiment, the processor 230 may comprise one or more multi-core processors and/or memory modules 250, which may function as data stores, buffers, etc. The processor 230 may be implemented as a general processor or may be part of one or more application specific integrated circuits (ASICs), field-programmable gate arrays (FPGAs), and/or digital signal processors (DSPs). Although illustrated as a single processor, the processor 230 is not so limited and may comprise multiple processors. The processor 230 may be configured to implement any of the adaptation schemes to communicate and/or signal metadata information.

FIG. 2 illustrates that a memory module 250 may be coupled to the processor 230 and may be a non-transitory medium configured to store various types of data. Memory module 250 may comprise memory devices including secondary storage, read-only memory (ROM), and random-access memory (RAM). The secondary storage is typically comprised of one or more disk drives, optical drives, solid-state drives (SSDs), and/or tape drives and is used for non-volatile storage of data and as an over-flow storage device if the RAM is not large enough to hold all working data. The secondary storage may be used to store programs that are loaded into the RAM when such programs are selected for execution. The ROM is used to store instructions and perhaps data that are read during program execution. The ROM is a non-volatile memory device that typically has a small memory capacity relative to the larger memory capacity of the secondary storage. The RAM is used to store volatile data and perhaps to store instructions. Access to both the ROM and RAM is typically faster than to the secondary storage.

The memory module 250 may be used to house the instructions for carrying out the system and methods described herein. In one embodiment, the memory module 250 may comprise a representation adaptation module 260 or a metadata module 270 that may be implemented on the processor 230. In one embodiment, the representation adaptation module 260 may be implemented on a client to select representations for media content segments using metadata information (e.g., quality information). In another embodiment, the metadata module 270 may be implemented on a server to associate and/or communicate metadata information and media content segments to one or more clients.

It is understood that by programming and/or loading executable instructions onto the network element 200, at least one of the processor 230, the cache, and the long-term storage are changed, transforming the network element 200 in part into a particular machine or apparatus, for example, a multi-core forwarding architecture having the novel functionality taught by the present disclosure. It is fundamental to the electrical engineering and software engineering arts that functionality that can be implemented by loading executable software into a computer can be converted to a hardware implementation by well-known design rules known in the art. Decisions between implementing a concept in software versus hardware typically hinge on considerations of stability of the design and number of units to be produced rather than any issues involved in translating from the software domain to the hardware domain. Generally, a design that is still subject to frequent change may be preferred to be implemented in software, because re-spinning a hardware implementation is more expensive than re-spinning a software design. Generally, a design that is stable will be produced in large volume may be preferred to be implemented in hardware (e.g., in an ASIC) because for large production runs the hardware implementation may be less expensive than software implementations. Often a design may be developed and tested in a software form and then later transformed, by well-known design rules known in the art, to an equivalent hardware implementation in an ASIC that hardwires the instructions of the software. In the same manner as a machine controlled by a new ASIC is a particular machine or apparatus, likewise a computer that has been programmed and/or loaded with executable instructions may be viewed as a particular machine or apparatus.

Any processing of the present disclosure may be implemented by causing a processor (e.g., a general purpose multi-core processor) to execute a computer program. In this case, a computer program product can be provided to a computer or a network device using any type of non-transitory computer readable media. The computer program product may be stored in a non-transitory computer readable medium in the computer or the network device. Non-transitory computer readable media include any type of tangible storage media. Examples of non-transitory computer readable media include magnetic storage media (such as floppy disks, magnetic tapes, hard disk drives, etc.), optical magnetic storage media (e.g. magneto-optical disks), compact disc read only memory (CD-ROM), compact disc recordable (CD-R), compact disc rewritable (CD-R/W), digital versatile disc (DVD), Blu-ray (registered trademark) disc (BD), and semiconductor memories (such as mask ROM, programmable ROM (PROM), erasable PROM), flash ROM, and RAM). The computer program product may also be provided to a computer or a network device using any type of transitory computer readable media. Examples of transitory computer readable media include electric signals, optical signals, and electromagnetic waves. Transitory computer readable media can provide the program to a computer via a wired communication line (e.g. electric wires, and optical fibers) or a wireless communication line.

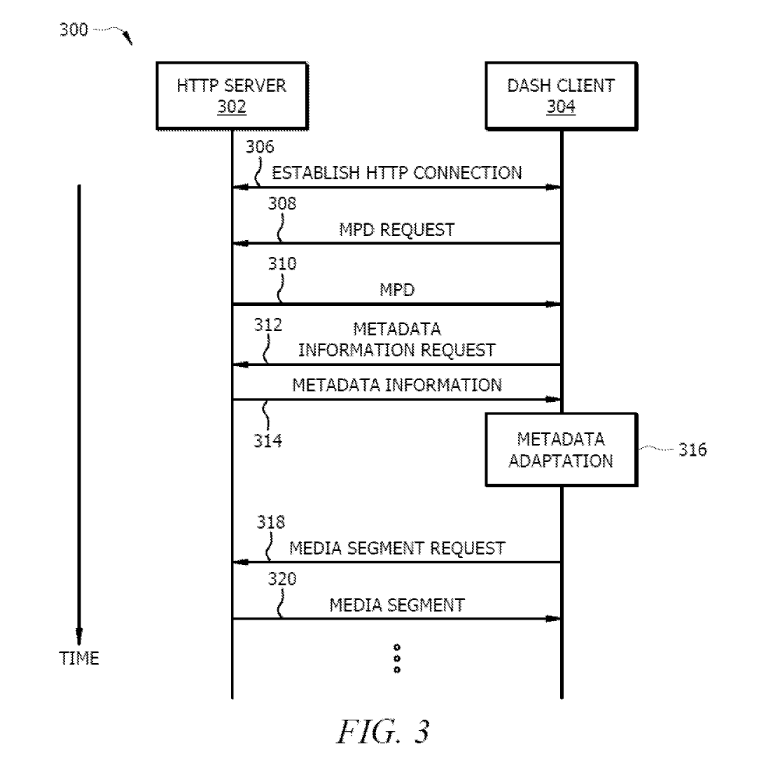

FIG. 3 is a protocol diagram of an embodiment of a DASH adaptation method 300. In an embodiment, an HTTP server 302 may communicate data content with a DASH client 304. The HTTP server 302 may be configured similar to HTTP server 104 and the DASH client 304 may be configured similar to DASH client 108 described in FIG. 1. The HTTP server 302 may receive media content from a content source (e.g., content source 102 as described in FIG. 1) and/or may generate media content. For example, the HTTP server 302 may store media content in memory and/or a cache. At step 306, the HTTP server 302 and the DASH client 304 may establish an HTTP connection. At step 308, the DASH client 304 may communicate an MPD by sending an MPD request to the HTTP server 302. The MPD request may comprise instructions for downloading, or receiving, segments of data content and metadata information from the HTTP server 302. At step 310, the HTTP server 302 may send an MPD to the DASH client 304 via HTTP. In other embodiments, the HTTP server 302 may deliver the MPD via HTTP secure (HTTPS), email, universal serial bus (USB) drives, broadcast, or any other type of data transport. Specifically in FIG. 3, the DASH client 304 may receive the MPD from the HTTP server 302 via the DAE (e.g., DAE 118 as described in FIG. 1), and the DAE may process the MPD in order to construct and/or issue requests from the HTTP server 302 for metadata content information and data content segments. Steps 306 and 308 may be optional and may be omitted in other embodiments.

At step 312, the DASH client 304 may send a metadata information request to the HTTP server 302. The metadata information request may be a request for a metadata segment of a metadata representation in a metadata set (e.g., a quality set, a quality segment, and/or quality information) associated with one or more media segments. At step 314, in response to receiving the metadata information request, the HTTP server 302 may send metadata information to the DASH client 304.

The DASH client 304 may receive, process, and/or format the metadata information. At step 316, the DASH client 304 may use the metadata information to select the next representation and/or representation for streaming. In one embodiment, the metadata information may comprise quality information. The DASH client 304 may use the quality information to select a representation level that maximizes the quality of experience for a user based on the quality information. A quality threshold may be determined and/or established by the DASH client 304 and/or an end-user. The end-user may determine a quality threshold based on performance requirements, subscriptions, interest in the content, historical available bandwidth, and/or personal preferences. The DASH client 304 may select a media segment that corresponds to a quality level that is greater than or equal to the quality threshold. Additionally, the DASH client 304 may also consider additional information (e.g., available bandwidth or bitrate) to select a media segment. For example, the DASH client 304 may also consider the amount of available bandwidth to deliver the desired media segment.

At step 318, the DASH client 304 may request a media segment from the HTTP server 302. For example, as instructed or informed by the MPD and based on the received metadata information, the DASH client 304 may send a media segment request for a media segment to the HTTP server 302 via the DAE (e.g., DAE 188 described in FIG. 1). The requested media segment may correspond with the representation level and/or adaption set determined using metadata information. At step 320, in response to receiving the media segment request, the HTTP server 302 may send a media segment to the DASH client 304. The DASH client 304 may receive, process, and/or format the media segment. For example, the media segment may be presented (e.g., visually and/or audibly) to a user. For example, after a buffering period, an application (e.g., application 114 as described in FIG. 1) may present the media segment for viewing via a GUI (e.g., GUI 116 as described in FIG. 1). The DASH client 304 may continue to send and/or receive metadata information and/or media segments to/from the HTTP server 302, similar to as previously disclosed with respect to steps 312-320.

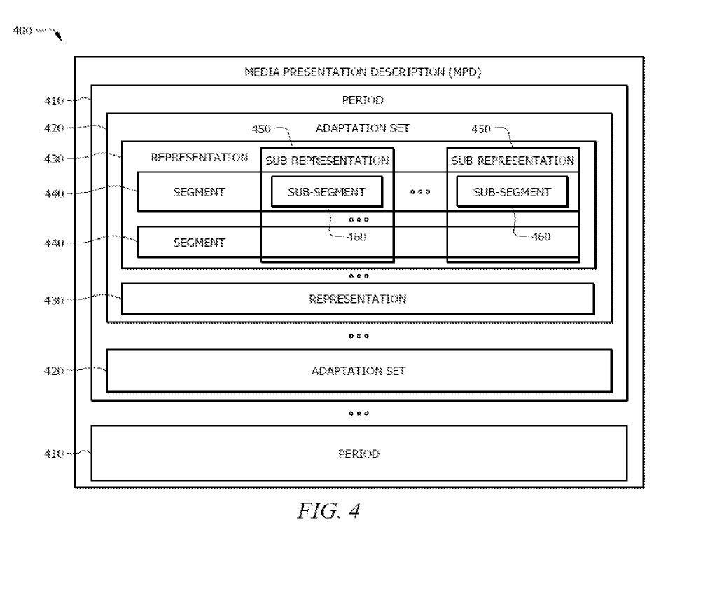

FIG. 4 is a schematic diagram of an embodiment of an MPD 400 for signaling media content and/or static metadata information. Static metadata information may be obtained from an MPD and may not vary with encoded media content over time. Metadata information may comprise quality information and/or performance information of the media content, such as, minimum bandwidth, frame rate, audio sampling rate, and/or other bitrate information. MPD 400 may be communicated from an HTTP server (e.g., HTTP server 104 as described in FIG. 1) to a DASH client (e.g., DASH client 304 as described in FIG. 3) to provide information for requesting and/or obtaining media content and/or timed metadata information, for example, as described in steps 306-320 in FIG. 3. Timed metadata information may also be obtained from an MPD and may vary with encoded media content over time. In an embodiment, an HTTP server may generate an MPD 400 to provide and/or enable metadata signaling. The MPD 400 is a hierarchical data model. In accordance with ISO/IEC 23009-1, the MPD 400 may be referred to as a formalized description for a media presentation for the purpose of providing a streaming service. A media presentation, in turn, may be referred to as a collection of data that establishes a presentation or media content. In particular, the MPD 400 may define formats to announce HTTP URLs, or network addresses, for downloading segments of data content. In one embodiment, the MPD 400 may be an Extensible Markup Language (XML) document. The MPD 400 may comprise a plurality of URLs pointing to one or more HTTP servers for downloading segments of data and metadata information.

The MPD 400 may comprise Period 410, Adaptation Set 420, Representation 430, Segment 440, Sub-Representation 450, and Sub-Segment 460 elements. The Period 410 may be associated with a period of data content. In accordance with ISO/IEC 23009-1, the Period 410 may typically represent a media content period during which a consistent set of encoded versions of media content is available. In other words, the set of available bitrates, languages, captions, subtitles, etc., does not change during a period. An Adaptation Set 420 may comprise a set of mutually interchangeable Representations 430. In various embodiments, an Adaptation Set 420 that comprises metadata information may be referred to as a metadata set. A Representation 430 may describe deliverable content, for example, an encoded version of one or more media content components. A plurality of temporally consecutive Segments 440 may form a stream or track (e.g., a media content stream or track).

A DASH client (e.g., DASH client 108 as described in FIG. 1) may switch between Representations 430 to adapt to network conditions or other factors. For example, the DASH client may determine if it can support a specific Representation 430 based on the metadata information (e.g., static metadata information) associated with the Representation 430. If not, then the DASH client may select a different Representation 430 that can be supported. A Segment 440 may be referred to as a unit of data associated with a URL. In other words, a Segment 440 may generally be the largest unit of data that can be retrieved with a single HTTP request using a single URL. The DASH client may be configured to download segments within selected Representation 430 until the DASH client ceases downloading or until the DASH client selects another Representation 430. Additional details for the Segment 440, the Sub-Representation 450, and the Sub-Segment 460 elements are described in ISO/IEC 23009-1.

The Period 410, Adaptation Set 420, Representation 430, Segment 440, Sub-Representation 450, and Sub-Segment 460 elements may be used to reference various forms of data content. In an MPD, elements and attributes may be similar to those defined in XML 1.0, Fifth Edition, 2008, which is incorporated herein by reference as if reproduced in its entirety. Elements may be distinguished from attributes by uppercase first letters or camel-casing, as well as bold face, though bold face is removed herein. Each element may comprise one or more attributes, which may be properties that further define the element. Attributes may be distinguished by a proceeding ‘@’ symbol. For instance, the Period 410 may comprise a “@ start” attribute that may specify when on a presentation timeline a period associated with the Period 410 begins.

As previously discussed, metadata information may also be referred to as timed-metadata information when the metadata information varies over time with an encoded media stream, and the terms may be used interchangeably throughout this disclosure. During a Period 410, one or more adaptation sets for metadata information may be available. For example, Table 1 comprises an embodiment of a list of adaptation sets for metadata information. For example, QualitySet, BitrateSet, and PowerSet may be adaptation sets that comprise timed metadata for quality, bitrate, and power consumption, respectively. An adaptation set name may generally describe a type of metadata information carried by the adaptation set. The adaptation set for metadata information may comprise a plurality of metadata representations. In one embodiment, a QualitySet may comprise a plurality of quality representations, which are described in Table 2. Alternatively, an adaptation set for metadata information may be a BitrateSet that comprises a plurality of bitrate representations or a PowerSet that comprises a plurality of power representations.

TABLE 1
An embodiment of semantics of a Period Element

| | | |
|---|---|---|
| Period | | Specifies the information of a Period. |
| . . . | . . . | . . . |
| AdaptationSet | 0 . . . N | May specify an Adaptation Set. At |
| | | least one Adaptation Set shall be |
| | | present in each Period. However, the |
| | | actual element may be present only in |
| | | a remote element if xlink is in use, |
| QualitySet | 0 . . . N | May specify a Quality Set. A Quality |
| | | Set is associated with an |
| | | Adaptation Set with the same value of |
| | | @id. |
| BitrateSet | 0 . . . N | May specify a Bitrate Set. A Bitrate |
| | | Set is associated with an |
| | | Adaptation Set with the same value of |
| | | @id. |
| PowerSet | 0 . . . N | May specify a Power Set. A Power Set |
| | | is associated with an |
| | | Adaptation Set with the same value of |
| | | @id. |

Legend:
For attributes: M = Mandatory, O = Optional, OD = Optional with Default Value, CM = Conditionally Mandatory.
For elements: <minOccurs> . . . <maxOccurs> (N = unbounded)
Note that the conditions only holds without using xlink:href. If linking is used, then all attributes are “optional” and <minOccurs = 0>
Elements are bold; attributes are non-bold and preceded with an @.

In Table 2, an adaptation set for metadata information may be signaled together with one or more corresponding adaptation sets for media content during a period. In one embodiment, the adaptation set for timed metadata information may be associated with the adaptation set for media content with about the same @id value. An adaptation set for timed metadata information may comprise a plurality of representations that comprise metadata information (e.g., quality information) about one or more media representations and may not comprise media data. As such, the adaptation set for metadata information may be distinguished from an adaptation set for media content and a metadata representation may be distinguished from a media representation. Each metadata representation may be associated with one or more media representations, for example, using a track-reference (e.g., a track-reference box ‘cdsc’). In an embodiment, an association may be on a set level. A metadata set and an adaptation set may share about the same value of @id. In another embodiment, an association may be on a representation level. A metadata representation and a media representation may share about the same value of representation@id. A metadata representation may comprise a plurality of metadata segments. Each metadata segment may be associated with one or more media segments. The metadata segment may comprise quality information associated with the content of the media segments and may be considered during a representation adaptation. A metadata segment may be divided into a plurality of sub-segments. For example, a metadata segment may comprise index information that documents metadata information, as well as, access information for each of the sub-segments. Signaling a metadata representation may identify which adaptation set for media content and/or which media representation in the adaptation set for media content the metadata representation is associated with. The time required to collect information for adaptation decisions may be reduced and a DASH client may retrieve the metadata information for multiple media representations in an adaptation set at one time. More than one type of metadata information may be provided at the same time. For instance, quality information may comprise information about the quality of media content (e.g., a media segment) derived from one or more quality metrics. An existing DASH specification may support signaling the metadata representation without significant modifications.

TABLE 2
An embodiment of semantics of a QualitySet element

| Element or | | |
|---|---|---|
| Attribute Name | Use | Description |
| MetadataSet | | Adaptation Set description. A metadata set may take a name |
| | | associated with the metadata type representation that it carries. |
| @xlink:href | O | May specify a reference to external Adaptation Set (e.g., |
| | | Metadata set) element |
| @xlink:actuate | OD | May specify the processing instructions, which can be either |
| | default: | “onLoad” or “onRequest.” |
| | ‘onRequest’ | |
| @id | O | May specify a unique identifier for this Adaptation Set in the |
| | | scope of the Period. The attribute may be unique in the scope |
| | | of the containing Period. The attribute may not be present in a |
| | | remote element. It may be of the same value as that of the |
| | | Adaptation Set with which the Metadata Set is associated. |
| Role | 0 . . . 1 | May specify the kind of metadata provided in the set. |
| BaseURL | 0 . . . N | May specify a base URL that can be used for reference |
| | | resolution and alternative URL selection. |
| SegmentBase | 0 . . . 1 | May specify default Segment Base information. Information in |
| | | this element may be overridden by information in the |
| | | Representation.SegmentBase. |
| SegmentList | 0 . . . 1 | May specify default Segment List information. Information in |
| | | this element may be overridden by information in the |
| | | Representation.SegmentList. |
| SegmentTemplate | 0 . . . 1 | May specify default Segment Template information. |
| | | Information in this element may be overridden by information |
| | | in the Representation.SegmentTemplate. |
| Representation | 0 . . . N | May specify a Representation. At least one Representation |
| | | element shall be present in each Adaptation Set. The actual |
| | | element may however be part of a remote element. |
| Period | | May specify the information of a Period |
| Adaptation Set | 0 . . . N | May specify an Adaptation Set. At least one Adaptation Set |
| | | may be present in each Period. However, the actual element |
| | | may be present only in a remote element if xlink is in use. |
| Metadata Set | 0 . . . N | May specify a Metadata Set. A Metadata Set may be |
| | | associated with an Adaptation Set with about the same @id |
| | | value. |

Legend:
For attributes: M = Mandatory, O = Optional, OD = Optional with Default Value, CM = Conditionally Mandatory.
For elements: <minOccurs> . . . <maxOccurs> (N = unbounded)
Elements are bold; attributes are non-bold and proceeded with an @.

Table 3 is an embodiment of semantics of a QualityMetric element used as a descriptor in an adaptation set that comprises timed metadata for quality. A scheme for the quality representation may be indicated using a uniform resource name (URN) as a value of attribute @schemeldUri (e.g., urn:mpeg:dash:quality:2013). For instance, the value of @schemeldUri may be urn:mpeg:dash:quality:2013 and the value of @value may indicate a metric for a quality measurement (e.g., PSNR, MOS, or SSIM).

TABLE 3
An embodiment of semantics of a QualityMetric element

| Element or | | |
|---|---|---|
| Attribute Name | Use | Description |
| QualityMetric | | |
| @schemeIdUri | M | The scheme is identified by |
| | | urn:mpeg:dash:quality_metric:2013. |
| @value | M | Indicates what metric is |
| | | used to express quality. |
| | | 1: PSNR |
| | | 2: MOS |
| | | 3. SSIM |

Legend:
For attributes: M = Mandatory, O = Optional, OD = Optional with Default Value, CM = Conditionally Mandatory.
For elements: <minOccurs> . . . <maxOccurs> (N = unbounded)
Elements are bold; attributes are non-bold and proceeded with an @.

A Role element (e.g., Representation.Role) may be used in an adaptation set for timed metadata information to indicate the metadata information type or a child element. The metadata information type may include, but is not limited to, quality, power, bitrate, decryption key, and event. Table 4 comprises an embodiment of a list of Role elements. Different Role values may be assigned for different metadata types.

TABLE 4
An embodiment of various Role elements

| Role@value | Description |
|---|---|
| quality | Quality information of media data |
| | may be provided in this representation |
| bitrate | Bitrate information of media data |
| | may be provided in this representation |
| power | Power consumption information of media data |
| | may be provided in this representation |
| decryption | Key information used for decryption of protected |
| key | media data may be provided in this representation |
| event | Media data related events may be |
| | provided in this representation |

Optionally, one or more of the Role elements may be extended with one or more additional attributes to indicate a metric used for a metadata information type. Table 5 is an embodiment of a Role element extension.

TABLE 5
An embodiment of a Role element extension

<xs:schema targetNamespace=“urn:mpeg:dash:metadata:2013”

attributeFormDefault=“unqualified”
elementFormDefault=“qualified”
xmlns:xs=“http://www.w3.org/2001/XMLSchema”
xmlns=“urn:mpeg:dash:metadata:2013”>
<!-- attribute that can be used within the DASH Role descriptor -->
<xs:attrtbute name=“metric” type=“xs:string”/>

</xs:schema>

In one embodiment, an adaptation set for metadata information may be located in an MPD 400 as an Adaptation Set 420. The adaptation set for metadata information may reuse some of the elements and/or attributes defined for another adaptation set for media content. The adaptation set for metadata information may use an identifier (e.g., @id attribute) to link and/or reference the adaptation set for metadata information to another adaptation set. The adaptation set for metadata information and the other adaptation set may share the same @id value. In another embodiment, the adaptation set for metadata information may associate with the other adaptation sets by setting an @assocationId and/or an @associationType, as shown in Table 6. The metadata representation may provide quality information for all the media representations in the adaptation set. The adaptation set for metadata information may appear as a pair with the other adaptation set for each period.

TABLE 6
An embodiment of semantics of a Representation Element

| | | |
|---|---|---|
| @associationId | O | Specifies all complementary Representations the Representation |
| | | depends on in the decoding and/or presentation process as a |
| | | whitespace-separated list of values of @id attributes. |
| | | If not present, the Representation can be decoded and presented |
| | | independently of any other Representation. |
| | | This attribute shall not be present where there are no |
| | | dependencies. |
| @associationType | O | Specifies the kind of dependency for each complementary |
| | | Representation the Representation depends on that has been |
| | | signaled with the @dependencyId attribute. Values taken by |
| | | this attribute are the reference types registered for the track |
| | | reference types at http://www.mp4ra.org/trackref.html. |
| | | If not present, it is assumed that the Representation depends on |
| | | the complementary Representations for decoding and/or |
| | | presentation process without more precise information. |
| | | This attribute shall not be present when @dependencyId is not |
| | | present. |

Table 7 and Table 8 may combine to form an embodiment of an entry for signaling the presence of quality information to a client using an association between an adaptation set for metadata information set (e.g., a Quality Set) and an adaptation set for media content. In such an embodiment, a metadata representation may be un-multiplexed. The QualitySet may comprise three representations having @id values of “v0,” “v1,” and “v3.” Each representation may be associated with a media representation having about the same value of @id. An association may be implemented on set level between QualitySet and AdaptationSet. For instance both may have an @id value of “video.” An association may also be implemented on a representation level where the representations share about the same value of @id. The adaptation set for metadata information may be associated with the adaptation set for media content using about the same identifier (e.g., a “video” identifier). The Role element in the adaptation set for metadata information may indicate that the adaptation set contains one or more metadata representations. In particular, the Role element may indicate that the metadata representations of the adaptation set for metadata information comprises quality information. In one embodiment, the metadata representation may not be multiplexed. Each metadata representation that corresponds to a media representation in the associated Adaptation Set may share about the same identifiers (e.g., “v0,” “v1,” or “v2”). Alternatively, when the adaptation sets are time aligned, the metadata representation may be multiplexed. For instance, quality information and bitrate information of representations in the adaption sets may be put in a metadata representation. Segment URLs in the metadata representation may be provided using a substantially similar template as used for media representations, however, a path (e.g., BaseURL) may be different. In one embodiment, the suffix of a metadata segment file may be “mp4m.”

TABLE 7
An embodiment of an entry for signaling
the presence of quality information

<?xml version=“1.0” encoding=“UTF-8”?>
<MPD

xmlns:xsi=“http://www.w3.org/2001/XMLSchema-instance”
xmlns=“urn:mpeg:DASH:schema:MPD:XXXX”
xsi:schemaLocation=“urn:mpeg:DASH:schema:MPD:xxxx”
type=“dynamic”
minimumUpdatePeriod=“PT2S”
timeShiftBufferDepth=“PT30M”
availabilityStartTime=“2011-12-25T12:30:00”
minBufferTime=“P74S”
profiles=“urn:mpeg:dash:profile:isoff-live:2011”>
<BaseURL>http://cdn1.example.com/</BaseURL>
<BaseURL>http://cdn2.example.com/</BaseURL>
<Period>

<!-- Video -->
<AdaptationSet

id=“video”
mimeType=“video/mp4”
codecs=“avc1.4D401F”
frameRate=“30000/1001”
segmentAlignment=“true”
startWithSAP=“1”>
<BaseURL>video/</BaseURL>
<SegmentTemplate timescale=“90000”
media=“$Bandwidth$/$Time$.mp4v”>

<SegmentTimeline>

<S t=“0” d=“180180” r=“432”/>

</SegmentTimeline>

</SegmentTemplate>
<Representation id=“v0” width=“320” height=“240”
bandwidth=“250000”/>
<Representation id=“v1” width=“640” height=“480”
bandwidth=“500000”/>
<Representation id=“v2” width=“960” height=“720”
bandwidth=“1000000”/>

</AdaptationSet>

TABLE 8
An embodiment of an entry for signaling
the presence of quality information

<!-- English Audio -->

<AdaptationSet mimeType=“audio/mp4” codecs=“mp4a.0x40”
lang=“en”

segmentAlignment=“0”>

<SegmentTemplate timescale=“48000”
media=“audio/en/$Time$.mp4a”>

<SegmentTimeline>

<S t=“0” d=“96000” r=“432”/>

</SegmentTimeline>

</SegmentTemplate>
<Representation id=“a0” bandwidth=“64000” />

</AdaptationSet>
<!-- French Audio -->
<AdaptationSet mimeType=“audio/mp4” codecs=“mp4a.0x40”
lang=“fr”

segmentAlignment=“0”>

<SegmentTemplate timescale=“48000”
media=“audio/fr/$Time$.mp4a”>

<SegmentTimeline>

<S t=“0” d=“96000” r=“432”/>

</SegmentTimeline>

</SegmentTemplate>
<Representation id=“a0” bandwidth=“64000” />

</AdaptationSet>

</Period>

<!-- Quality Information for Video -->

<QualitySet

id=“video”
segmentAlignment=“true”
startWithSAP=“1”>
<Role schemeIdUri=“urn:mpeg:dash:metadata:2013”
value=“quality”/>
<BaseURL>video_quality/</BaseURL>
<SegmentTemplate timescale=“90000”
media=“$Bandwidth$/$Time$.mp4m”>

<SegmentTimeline>

<S t=“0” d”180180” r=“432”/>

</SegmentTimeline>

</SegmentTemplate>
<Representation id=“v0” bandwidth=“1000”/>
<Representation id=“v1” bandwidth=“1000”/>
<Representation id=“v2” bandwidth=“1000”/>

</AdaptationSet>

</MPD>

Table 9 and Table 10 may combine to form another embodiment of an entry for signaling presence of quality information to a client using an association between a metadata set and an adaptation set for media content. In such an embodiment, the metadata representation may be multiplexed. A MetadataSet may comprise one representation. The MetadataSet may comprise quality information for media representations (e.g., “v0,” “v1,” or “v2) in the AdaptationSet. An association may be on a set level between the MetadataSet and the AdaptationSet.

TABLE 9
An embodiment of an entry for signaling
the presence of quality information

<?xml version=“1.0” encoding=“UTF-8”?>
<MPD

xmlns:xsi=“http:/www.w3.org/2001/XMLSchema-instance”
xmlns=“urn:mpeg:DASH:schema:MPD:XXXX”
xsi:schemaLocation=“urn:mpeg:DASH:schema:MPD:xxxx”
type=“dynamic”
minimumUpdatePeriod=“PT2S”
timeShiftBufferDepth=“PT30M”
availabilityStartTime=“2011-12-25T12:30:00”
minBufferTime=“PT4S”
profiles=“urn:mpeg:dash:profile:isoff-live:2011”>
<BaseURL>http://cdn1.example.com/</BaseURL>
<BaseURL>http://cdn2.example.com/</BaseURL>
<Period>

<!-- Video -->
<AdaptationSet

id=“video”
mimeType=“video/mp4”
codecs=“avc1.4D401F”
frameRate=“30000/1001”
segmentAlignment=“true”
startWithSAP=“1”>
<BaseURL>video/</BaseURL>
<SegmentTemplate timescale=“90000”
media=“$Bandwidth$/$Time$.mp4v”>

<SegmentTimeline>

<S t=“0” d=“180180” r=“432”>

</SegmentTimeline>

</SegmentTemplate>
<Representation id=“v0” width=“320” height=“240”
bandwidth=“250000”/>
<Representation id=“v1” width=“640” height=“480”
bandwidth=”500000”/>
<Representation id=“v2” width=“960” height=“720”
bandwidth=“1000000”/>

</AdaptationSet>
<!-- English Audio -->

TABLE 10
An embodiment of an entry for signaling
the presence of quality information

<AdaptationSet mimeType=“audio/mp4” codecs=“mp4a.0x40”
lang=“en” segmentAlignment=“0”>

<SegmentTemplate timescale=“48000”
media=“audio/en/$Time$.mp4a”>

<SegmentTimeline>
<S t=“0” d=“96000” r=“432”/>
</SegmentTimeline>

</SegmentTemplate>
<Representation id=“a0” bandwidth=“64000” />

</AdaptationSet>
<!-- French Audio -->
<AdaptationSet mimeType=“audio/mp4” codecs=“mp4a.0x40”
lang=“fr”

segmentAlignment=“0”>

<SegmentTemplate timescale=“48000”
media=“audio/fr/$Time$.mp4a”>

<SegmentTimeline>

<S t=“0” d=“96000” r=“432”/>

</SegmentTimeline>

</SegmentTemplate>
<Representation id=“a0” bandwidth=“64000” />

</AdaptationSet>

</Period>

<!--Quality Information for Video -->

<QualitySet

id=“video”
segmentAlignment=“true”
startWithSAP=“1”>
<Role schemeIdUri=“urn:mpeg:dash:metadata:2013”
value=“quality” metric=“SSIM” />
<BaseURL>video_quality/</BaseURL>
<SegmentTemplate timescale=“90000”
index=“$Bandwidth$/$Time$.mp4m”>

<SegmentTimeline>

<S t=“0” d=“180180” r=“432”/>

</SegmentTimeline>

</SegmentTemplate>
<Representation bandwidth=“1000”/>

</QualitySet>

</MPD>

A media presentation may be contained in one or more files. A file may comprise the metadata for a whole presentation and may be formatted as described in ISO/IEC 14496-12 titled, “Information technology—Coding of audio-visual objects—Part 12: ISO base media file format,” which is hereby incorporated by reference as if reproduced in its entirety. In one embodiment, the file may further comprise the media data for the presentation. An ISO-base media format file (BMFF) file may carry timed media information for a media presentation (e.g., a collection of media content) in a flexible and extensible format that may facilitate interchange, management, editing, and presentation of media content. Alternatively, a different file may comprise the media data for the presentation. A file may be an ISO file, an ISO-BMFF file, an image file, or other formats. For example, the media data may be a plurality of joint photographic expert group (JPEG) 2000 files. The file may comprise timing information, framing (e.g., position and size) information. The file may comprise media tracks (e.g., a video track, an audio track, and a caption track) and a metadata track. The tracks may be identified with a track identifier that uniquely identifies a track. The file may be structured as a sequence of objects and sub-objects (e.g., an object within another object). The objects may be referred to as container boxes. For example, a file may comprise a metadata box, a movie box, a movie fragment box, a media box, a segment box, a track reference box, a track fragment box, and a track run box. A media box may carry media data (e.g., video picture frames and/or audio) of a media presentation and a movie box may carry metadata of the presentation. A movie box may comprise a plurality of sub-boxes that carry metadata associated with the media data. For example, a movie box may comprise a video track box that carries descriptions of video data in the media box, an audio track box that carries descriptions of audio data in the media box, and a hint box that carries hints for streaming and/or playback of the video data and/or audio data. Additional details for a file and objects within the file may be as described in ISO/IEC 14496-12.

Timed metadata information may be stored and/or communicated using an ISO-BMFF framework and/or an ISO-BMFF box structure. For instance, timed metadata information may be implemented using a track within an ISO-BMFF framework. A timed metadata track may be contained in a different movie fragment than the media track it is associated with. A metadata track may comprise one or more samples, one or more track runs, one or more track fragments, and one or more movie fragments. Timed metadata information within the metadata track may be associated with media content within a media track using various levels of granularity including, but not limited to, a sample level, a track run level, a track fragment level, a movie fragment level, a group of consecutive movie fragments (e.g., a media sub-segment) level, or any other suitable level of granularity as would be appreciated by one of ordinary skill in the art upon viewing this disclosure. A media track may be divided into a plurality of movie fragments. Each of the media fragments may comprise one or more track fragments. A track fragment may comprise one or more track runs. A track run may comprise a plurality of consecutive samples. A sample may be an audio and/or video sample. Additional details for an ISO-BMFF framework may be as described in ISO/IEC 14496-12.

In one embodiment, timed metadata information may comprise quality information for encoded media content. In other embodiments, metadata information may comprise bitrate information, or power consumption information for encoded media content. Quality information may refer to the coding quality of the media content. Quality of the encoded media data may be measured and represented in several granularity levels. Some examples of granularity levels may include a time interval of a sample, a track run (e.g., a collection of samples), a track fragment (e.g., a collection of track runs), a movie fragment (e.g., a collection of track fragments), and a sub-segment (e.g., a collection of movie fragments). A content producer may select a granularity level, compute quality metrics for media content at the selected granularity level, and store the quality metrics on a content server. The quality information may be an objective measurement and/or subjective measurement and may comprise peak signal-to-noise ratio (PSNR), mean opinion score (MOS), structural similarity (SSIM) index, frame significance (FSIG), mean signal error (MSE), multi-scale structural similarity index (MS-SSIM), perceptual evaluation of video quality (PEVQ), video quality metric (VQM), and/or any other quality metric as would be appreciated by one of ordinary skill in the art upon viewing this disclosure.

In one embodiment, quality information may be carried in a quality track in a media file. A quality track may be described by a data structure that comprises parameters, such as a quality metric type, granularity level, and scale factor. Each sample in the quality track may comprise a quality value, where the quality value may be of the quality metric type. In addition, each sample may indicate a scale factor for the quality value, where the scale factor may be a multiplication factor that scales the range of the quality values. The quality track may also comprise metadata segment index boxes and the metadata segment index boxes may comprise a substantially similar structure as segment index boxes as defined in ISO/IEC 14496-12. Alternatively, the quality information may be carried as a metadata track as described in ISO/IEC 14496-12. For example, a video quality metric entry may be as shown in Table 6. The quality metric may be located in a structure (e.g., a description box QualityMetricsConfigurationsBox) that describes the quality metrics present in each sample and the field size used for each metric value. In Table 11, each sample is an array of quality values corresponding one-to-one to the declared metrics. Each value may be padded by preceding zeros, as needed, to the number of bytes indicated by the variable field_size_bytes. In such an example, the variable accuracy may be a fixed point 14.2 number that indicates the precision of the sample in the sample box. Additionally, term “0x000001” in the condition statement may indicate the value accuracy (e.g., accurate to about 0.25). For a quality metric that is an integer value (e.g., MOS), the corresponding value may be 1 (e.g., 0x0004).

TABLE 11
An embodiment of a sample entry for a video quality metric

aligned(8) class QualityMetricsSampleEntry( )

extends MetadataSampleEntry (‘vqme’) {

QualityMetricsConfigurationBox( );

}
aligned(8) class QualityMetricsConfigurationBox

extends FullBox(‘vgmC’, version=0, flags){
unsigned int(8) fields_size_bytes;
unsigned int(8) metric_count;
for (i = 1 ; i <= metric_count ; i++){

unsigned int(32) metric_code;
if (flags = 0x000001)

unsigned int(16) accuracy; //optional

}

}

Table 12 is an embodiment of syntax for an overall description of quality information. The variable metric_type may indicate a metric to express quality (e.g., 1:PSNR, 2:MOS, or 3:SSIM). In an embodiment, the box may be located in a segment structure (e.g., after a segment type box ‘styp’) or in movie structure (e.g., movie box ‘moov’).

TABLE 12
An embodiment of syntax for quality information

aligned(8) class SegmentIndexBox extends FullBox(‘qinf’, version = 0, 0)
{

unsigned int(4) metric_type
unsigned int(28) reserved;

}

In another example, the metadata representation may be a power representation that comprises power consumption information about one or more Representations 430. For example, the power consumption information may provide information about the power consumption of a segment based on the bandwidth consumption and/or power requirements. In another embodiment, the metadata information may comprise encryption and/or decryption information that is associated with one or more media representations. The encryption and/or decryption information may be retrieved on-demand. For instance, the encryption and/or decryption information may be retrieved when a media segment is downloaded and encryption and/or decryption is required. Additional details for metadata information metrics may be as described in ISO/IEC CD 23001-10 titled, “Information technology—MPEG systems technologies—Part 10: Carriage of Timed Metadata Metrics of Media in ISO Base Media File Format,” which is hereby incorporated by reference as if reproduced in its entirety. The metadata information may be stored in the same (e.g., the same server) or in a different location (e.g., a different server) than the media content. That is, the MPD 400 may reference one or more locations for retrieving media content and metadata information.

Table 13 is an embodiment of syntax of a quality segment. For example, the syntax in Table 13 may be used when a quality segment is not divided into sub-segments.

TABLE 13
An embodiment of syntax of a segment

aligned(8) class SegmentIndexBox extends FullBox(‘qdx2’, version, 0) {

unsigned int(32) reference_ID;
unsigned int(16) quality_value;
unsigned int(18) scales_factor;

}

Table 14 is an embodiment of syntax of a quality segment comprising sub-segments. The variable quality_value may indicate the quality of the media data in the referenced sub-segment. The variable scale_factor may control the precision of the quality_value. Additional syntax details may be as described in ISO/IEC JTC1/SC29/WG11/MPEG2013/m28168 titled, “In Band Signaling for Quality Driven Adaptation,” which is here by incorporated by reference as if reproduced in its entirety.

TABLE 14
An embodiment of syntax of a segment comprising sub-segments

aligned(8) class SegmentIndexBox extends FullBox(‘qdx1’, version, 0) {

unsigned int(32) reference_ID;
unsigned int(32) timescale;
if (version==0)

{

unsigned int(32) earliest_presentation_time;
unsigned int(32) first_offset;

}
else
{

unsigned int(64) earliest_presentation_time;
unsigned int(64) first_offset;

}

unsigned int(16) reserved = 0;
unsigned int(16) reference_count;
for(i=1; i <= reference_count; i++)
{

| bit (1) | reference_type; |
|---|---|
| unsigned int(31) referenced_size; | |
| unsigned int(32) subsegment_duration; | |
| bit(1) | starts_with_SAP; |
| unsigned int(3) SAP_type; | |
| unsigned int(28) SAP_delta_time; | |
| if(reference_type == 0) | //if media data is referenced |

{

unsigned int(16) quality_value;
unsigned int(16) scale_factor;

}

}

}

Table 15 is an embodiment of a sample description entry for a quality metadata track. The quality_metric value may indicate the metric used for a quality measurement. The granularity value may indicate the level of association between the quality metadata track and a media track. For instance, a value of one may indicate a sample level quality description, a value of two may indicate a track run level quality description, a value of three may indicate a track fragment level of quality description, a value of four may indicate a movie fragment level of quality description, and a value of five may indicate a sub-segment level quality description. The scale_factor value may indicate a default scale factor.

TABLE 15
An embodiment of a sample description
entry for a quality metadata track

Aligned(8) class QualityMetaDataSampleEntry( ) extends
MetaDataSampleEntry (‘metq’) {

unsigned int(8) quality_metric;
unsigned int(8) granularity;
unsigned int(8) scale_factor;

}

Table 16 is an embodiment of a sample entry for a quality metadata track. The quality_value value may indicate the value of the quality metric. The scale_factor value may indicate the precision of the quality metric. When the scale_factor value is equal to about zero, the default scale_factor value in the sample description box (e.g., sample description entry as described in Table 15) may be used. When the scale_factor value is not equal to about zero, the scale_factor value may override the default scale_factor in the sample description box.

TABLE 16
An embodiment of a sample entry for a quality metadata track

aligned(8) class QualitySample {

unsigned int(8) quality_value;
unsigned int(8) scale_factor;

}

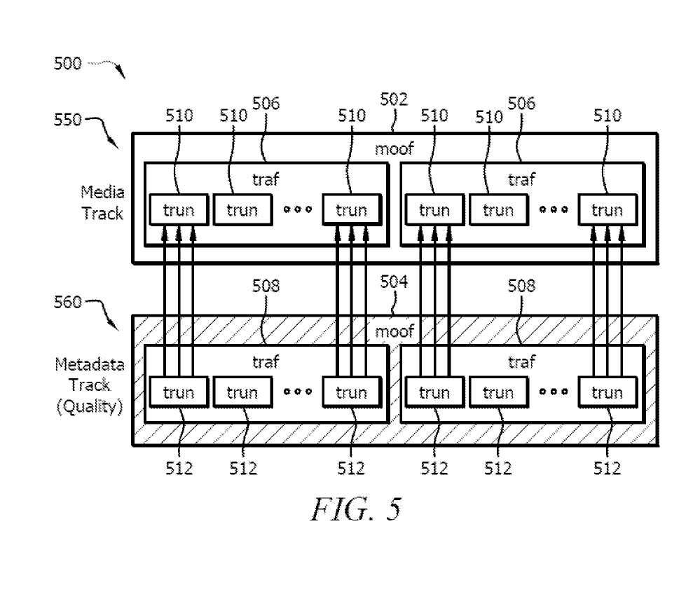

FIGS. 5-12 are various embodiments of associations between media content (e.g., a media track) and metadata information (e.g., metadata track). FIGS. 5-12 are shown for illustrative purposes and other associations between media content and metadata information may be employed as would be appreciated by one of ordinary skill in the art upon viewing this disclosure.

FIG. 5 is a schematic diagram of an embodiment of a sample level metadata association 500. Metadata association 500 may comprise a media track 550 and a metadata track 560 and may be configured to associate the media track 550 with the metadata track 560 on a sample level (e.g., a sample level quality description). The media track 550 and/or the metadata track 560 may be obtained using an MPD described in FIG. 3. The MPD may be configured similar to MPD 400 described in FIG. 4. The media track 550 may comprise a movie fragment box 502, one or more track fragment boxes 506, and one or more track run boxes 510 that comprise a plurality of samples. When the metadata track 560 may comprise quality information, the metadata track 560 may also be referred to as a quality track. The metadata track 560 may comprise a movie fragment box 504, one or more track fragment boxes 508, and one or more track run boxes 512 that comprise a plurality of samples. In such an embodiment, the number or movie fragment boxes, the number of track fragment boxes in each movie fragment box, the number of track run boxes in each track fragment box, and the number of samples in each track run box for the metadata track 560 may be about the same as those in the corresponding media track 550 associated with the metadata track 560. There may be about a one-to-one mapping between the metadata track 560 and the media track 550 on a movie fragment level, a track fragment level, a track run level, and a sample level. A sample within the metadata track 560 may span the duration of a corresponding sample within the media track 550 associated with the metadata track 560.

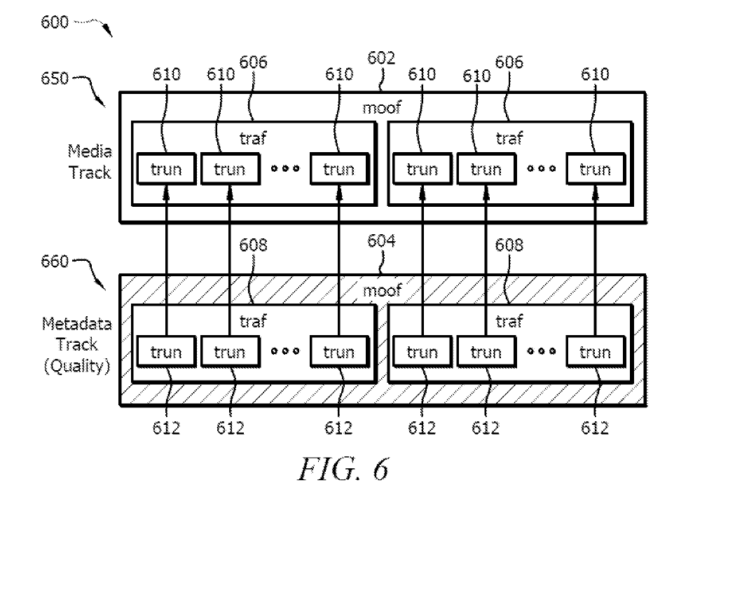

FIG. 6 is a schematic diagram of an embodiment of a track run level metadata association 600. Metadata association 600 may comprise a media track 650 and a metadata track 660 and may be configured to associate the media track 650 with the metadata track 660 on a track run level (e.g., a track run level quality description). The media track 650 and the metadata track 660 may be obtained using an MPD as described in FIG. 3. The MPD may be configured similar to MPD 400 described in FIG. 4. The media track 650 may comprise a movie fragment box 602, one or more track fragment boxes 606, and one or more track run boxes 610 that comprise a plurality of samples. The metadata track 660 may comprise a movie fragment box 604, one or more track fragment boxes 608, and one or more track run boxes 612 that comprise a plurality of samples. In such an embodiment, the number of movie fragment boxes, the number of track fragment boxes in each movie fragment box, and the number of track run boxes in each track fragment box for the metadata track 660 may be about the same as those in the corresponding media track 650 associated with the metadata track 660. There may be about a one-to-one mapping between the metadata track 660 and the media track 650 on a movie fragment level, a track fragment level, and a track run level. A sample within the metadata track 660 may span over about the sum of the durations of about all the samples in a corresponding track run box of the media track 650.

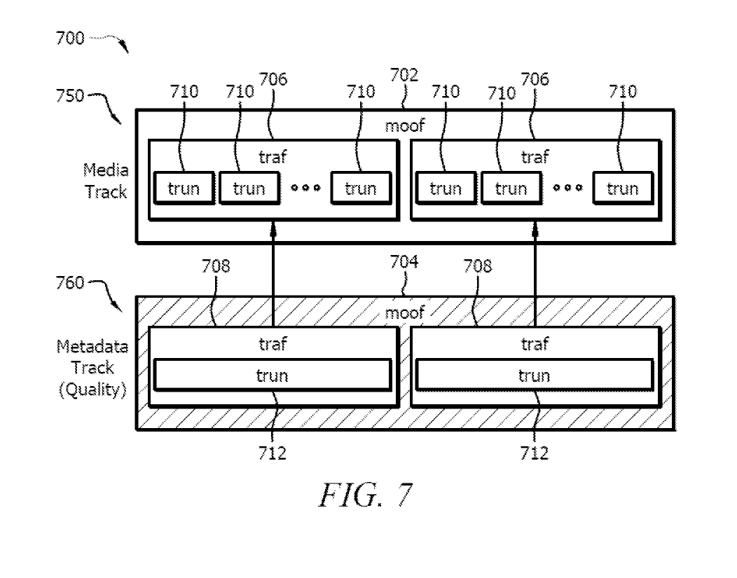

FIG. 7 is a schematic diagram of an embodiment of a track fragment level metadata association 700. Metadata association 700 may comprise a media track 750 and a metadata track 760 and may be configured to associate the media track 750 with the metadata track 760 on a track fragment level (e.g., a track fragment level quality description). The media track 750 and the metadata track 760 may be obtained using an MPD as described in FIG. 3. The MPD may be configured similar to MPD 400 described in FIG. 4. The media track 750 may comprise a movie fragment box 702, one or more track fragment boxes 706, and one or more track run boxes 710 that comprise a plurality of samples. The metadata track 760 may comprise a movie fragment box 704, one or more track fragment boxes 708, and one or more track run boxes 712 that comprise a plurality of samples. In such an embodiment, the number of movie fragment boxes and the number of track fragment boxes in each movie fragment box for the metadata track 760 may be about the same as those in the corresponding media track 750 associated with the metadata track 760. There may be about a one-to-one mapping between the metadata track 760 and the media track 750 on a movie fragment level and a track fragment level. A sample within the metadata track 760 may span over about the sum of the durations of about all the samples in a corresponding track fragment box of the media track 750.

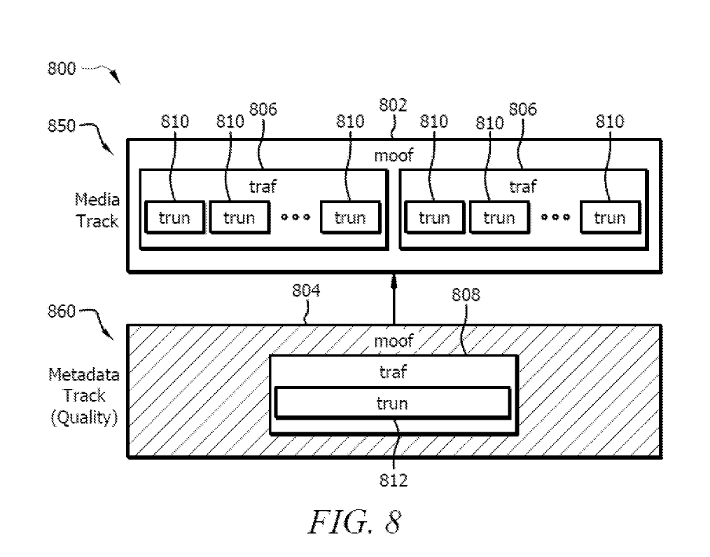

FIG. 8 is a schematic diagram of an embodiment of a movie fragment level metadata association 800. Metadata association 800 may comprise a media track 850 and a metadata track 860 and may be configured to associate the media track 850 with the metadata track 860 on a movie fragment level (e.g., a movie fragment level quality description). The media track 850 and the metadata track 860 may be obtained using an MPD as described in FIG. 3. The MPD may be configured similar to MPD 400 described in FIG. 4. The media track 850 may comprise a movie fragment box 802, one or more track fragment boxes 806, and one or more track run boxes 810 that comprise a plurality of samples. The metadata track 860 may comprise a movie fragment box 804, one or more track fragment boxes 808, and one or more track run boxes 812 that comprise a plurality of samples. In such an embodiment, the number of movie fragment boxes for the metadata track 860 may be about the same as in the corresponding media track 850 associated with the metadata track 860. There may be about a one-to-one mapping between the metadata track 860 and the media track 850 on a movie fragment level. A sample within the metadata track 860 may span over about the sum of the durations of about all the samples in a corresponding movie fragment box of the media track 850.

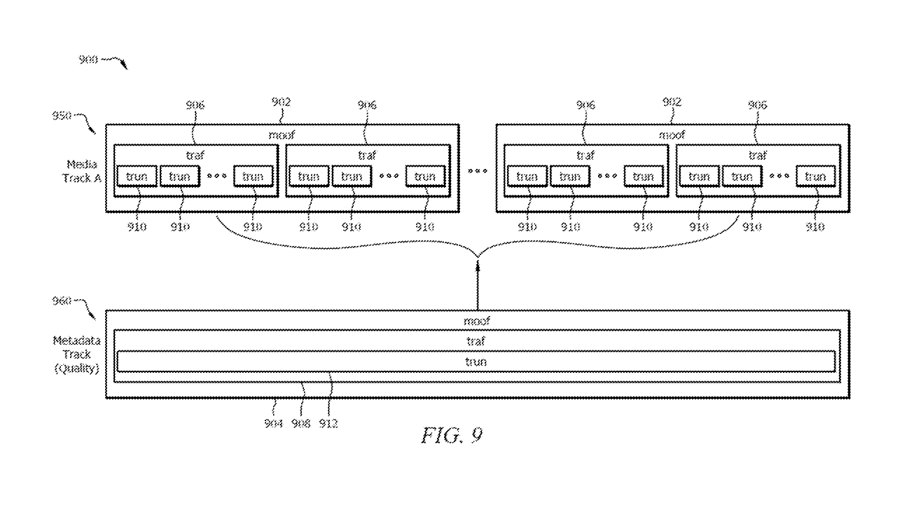

FIG. 9 is a schematic diagram of an embodiment of a sub-segment level metadata association 900. Metadata association 900 may comprise a media track 950 and a metadata track 960 and may be configured to associate the media track 950 with the metadata track 960 on a sub-segment level (e.g., a movie fragment level quality description). The media track 950 and the metadata track 960 may be obtained using an MPD as described in FIG. 3. The MPD may be configured similar to MPD 400 described in FIG. 4. A sub-segment level association may comprise an association between the metadata track 960 and a plurality of movie fragments. The media track 950 may comprise a plurality movie fragment boxes 902, one or more track fragment boxes 906, and one or more track run boxes 910 that comprise a plurality of samples. The metadata track 960 may comprise a movie fragment box 904, one or more track fragment boxes 908, and one or more track run boxes 912 that comprise a plurality of samples. In such an embodiment, the number of movie fragment boxes for the metadata track 960 may be less than the number of movie fragment boxes in the corresponding media track 950 associated with the metadata track 960. In one embodiment, there may be about one track run box 912 per track fragment box 908 and about one sample per track run box 912 for the metadata track 960.

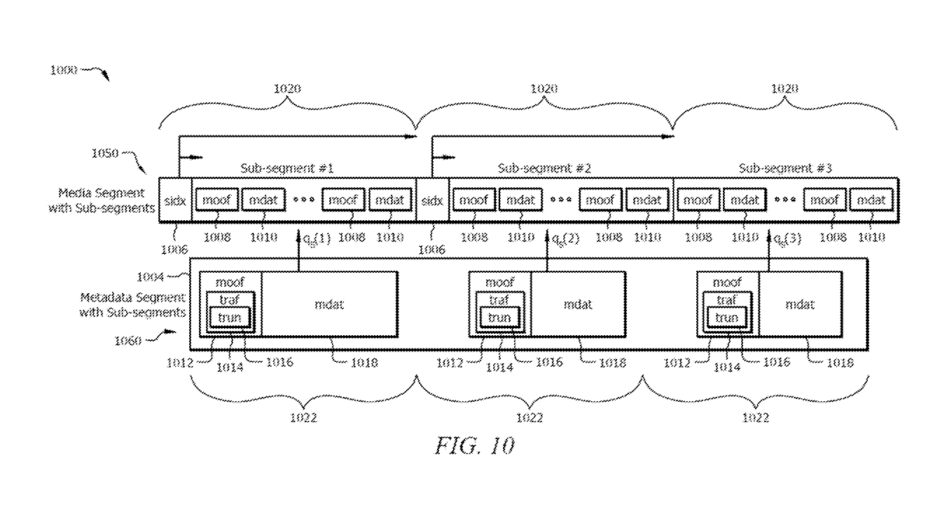

FIG. 10 is a schematic diagram of an embodiment of a media segment level metadata association 1000. In various embodiments, metadata information may be associated with media content on a media segment and/or media sub-segment level. Metadata association 1000 may comprise a media segment 1050 and a metadata segment 1060 and may be configured to associate the media segment 1050 with the metadata segment 1060 on a media segment and a media sub-segment level. The media track 1050 and the metadata track 1060 may be obtained using an MPD as described in FIG. 3. The MPD may be configured similar to MPD 400 described in FIG. 4. The media segment 1050 may comprise a plurality of sub-segments 1020 comprising one or more movie fragment boxes 1008 and one or more media data boxes 1010. One or more of the sub-segments 1020 may also be indexed using a segment index 1006. Similarly, the metadata segment 1060 may comprise a plurality of sub-segments 1022 associated with sub-segments 1020 of the media segment 1050. A sub-segment 1022 may comprise a movie fragment box 1012, a track fragment box 1014, a track run box 1016, and a media data box 1018.

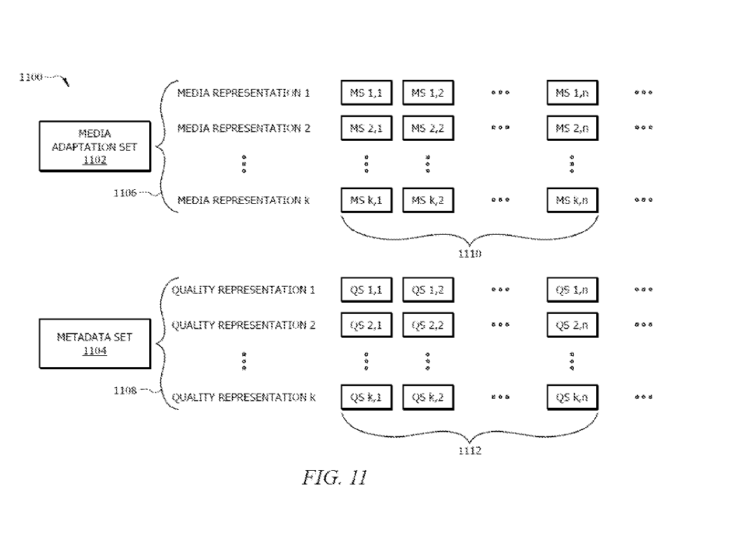

FIG. 11 is a schematic diagram of an embodiment of an adaptation set level metadata association 1100. Metadata association 1100 may comprise an association between an adaptation set for media content 1102 and an adaptation set for metadata information 1104. An adaptation set for media content 1102 and/or an adaptation set for metadata information 1104 may be configured similar to Adaptation Set 420 described in FIG. 4. The adaptation set for metadata information 1104 may comprise metadata information associated with the adaptation set for media content 1102. The adaptation set for media content 1102 may comprise a plurality of media representations 1106 that each comprises a plurality of media segments 1110. The adaptation set for metadata information 1104 may be a Quality Set comprising quality information. The adaptation set for metadata information 1104 may comprise a plurality of quality representations 1108 that each comprises a plurality of quality segments 1112. In one embodiment, the association between the media segments 1110 and the quality segments 1112 may be a one-to-one association. Each media segment (MS) 1-n in each media representation 1-k may have a corresponding quality segment (QS) 1-n in a corresponding quality representation 1-k. For example, a media segment 1,1 may correspond to a quality segment 1,1, a media segment 1,2 may correspond to a quality segment 1,2, and so on. Alternatively, a metadata segment may correspond to a plurality of media segments within a corresponding media representation. For example, a quality segment may correspond to a first half of the consecutive media segments in a media representation and a subsequent quality segment may correspond to a second half of the consecutive media segments in the media representation.

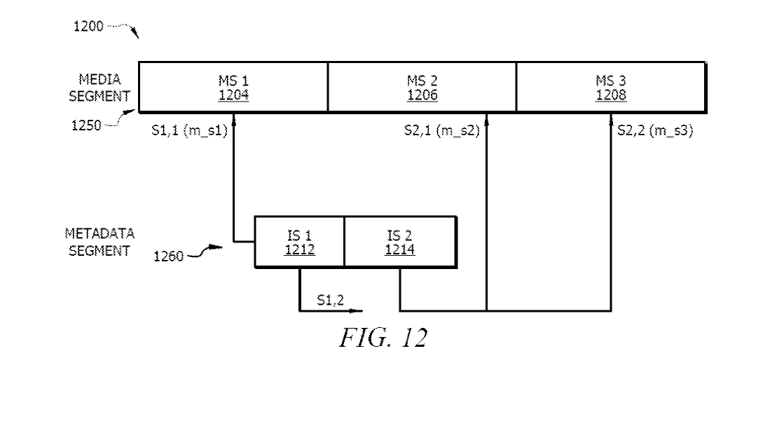

FIG. 12 is a schematic diagram of an embodiment of a media sub-segment level metadata association 1200. In an embodiment, a metadata segment 1260 may be associated with one or more media sub-segments 1250. The metadata segment 1260 may be configured similar to Segment 440 and the media sub-segment may be configured similar to Sub-Segments 460 as described in FIG. 4. In FIG. 6, the media segment 1250 may comprise a plurality of media sub-segments 1204-1208. A metadata segment 1260 may be associated with media sub-segments 1204-1208. The metadata segment 1260 may comprise a plurality of segment boxes (e.g., segment index boxes 1212 and 1214) to document the media sub-segments 1204-1208. The segment index box 1212 may document the media sub-segment 1204 and the segment index box 1214 may document the media sub-segments 1206 and 1208. For example, the segment index box 1212 may use an index S1,1(m_s1) to reference the media sub-segment 1204 and the segment index box 1214 may use the indexes S2,1(m_s2) and S2,2(m_s3) to reference the media sub-segments 1206 and 1208, respectively.

Table 17 is an embodiment of a metadata segment index box entry. The rep_num value may indicate the number of representations for which metadata information may be provided in the box. When the referenced item is media content (e.g., a media sub-segment), the anchor point may be at the beginning of the top-level segment. For instance, the anchor point may be the beginning of a media segment file when each media segment is stored in a separate file. When the referenced item is an indexed media segment, the anchor point may be the first byte following the quality index segment box.

TABLE 17
An embodiment of a metadata segment index box entry

aligned(8) class QualitySampleBox extends Box(‘qlty’){

unsigned int(8) scale_factor;
unsigned int(24) value; //value of metadata,e.g. value of PSNR for
quality

}
aligned(8) class MetadataSegmentIndexBoxextends FullBox(‘msix’,
version, flag) {
unsigned int(16) rep_num;
if (flag & 0x0001) //the box contains only one metadata tracks
rep_num = 1;

```
for(i=1; i <=rep_num; i++)
{
  unsigned int(32) reference_ID;
  unsigned int(32) timescale;
```

if (version==0)

{

unsigned int(32) earliest_presentation_time;
unsigned int(32) first_offset;

}

else

{

unsigned int(64) earliest_presentation_time;
unsigned int(64) first_offset;

}

unsigned int(16) reserved = 0;
unsigned int(16) reference_count;
for(i=1; i <= reference_count; i++)
{

| | |
|---|---|
| bit (1) | reference_type; |

| | |
|---|---|
| unsigned int(31) | referenced_size; |
| unsigned int(32) | subsegment_duration; |

| | |
|---|---|
| bit(1) | starts_with_SAP; |

| unsigned int(3) SAP_type; | |
|---|---|
| unsigned int(28) | SAP_delta_time; |

if (reference_type == 0}
QualitySampleBox( ); //quality information

}

}

}

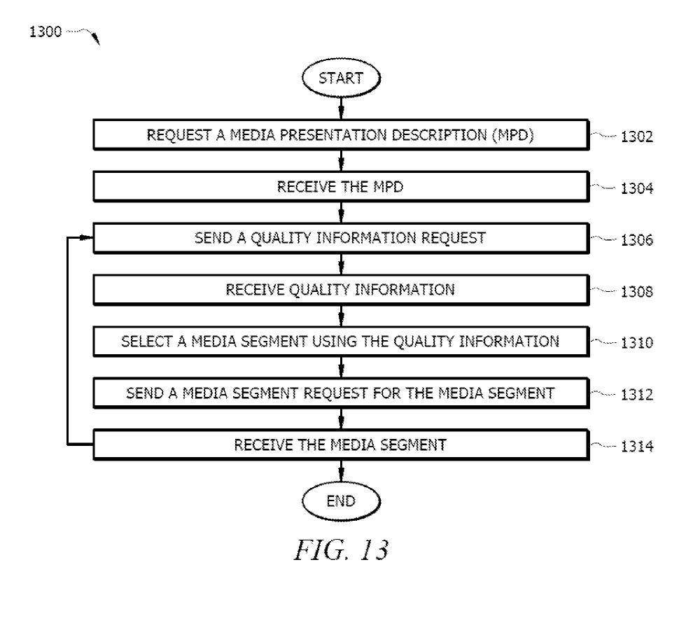

FIG. 13 is a flowchart of an embodiment of a representation adaptation method 1300. In an embodiment, the representation adaptation method 1300 may be implemented on a client (e.g., DASH client 108 as described in FIG. 1) to select representations for media content segments using quality information. At step 1302, method 1300 may request an MPD (e.g., MPD 400 described in FIG. 4) that comprises instructions and/or information for downloading or receiving segments of data content and metadata information. At step 1304, method 1300 may receive the MPD. Method 1300 may parse the MPD and may determine that timed metadata information (e.g., quality information) is available. For instance, timed metadata information may be contained in one or more metadata representations. Steps 1302 and 1304 may be optional and in an embodiment may be omitted. At step 1306, method 1300 may send a quality information request. At step 1308, method 1300 may receive the quality information. Method 1300 may map the quality of the media segments within one or more representations in an adaptation set. At step 1310, method 1300 may select a media segment using the quality information. For example, method 1300 may use an operation as described in step 316 of FIG. 3. Additionally, method 1300 may select the media segment by considering an available bandwidth, bitrates, a buffer size, and overall smoothness of streaming quality. At step 1312, method 1300 may send a media segment request that requests the media segment selected using the quality information. At step 1314, method 1300 may receive the media segment. Method 1300 may continue to request and/or receive quality information and/or media segments, similar to as previously disclosed with respect to steps 1306-1314.

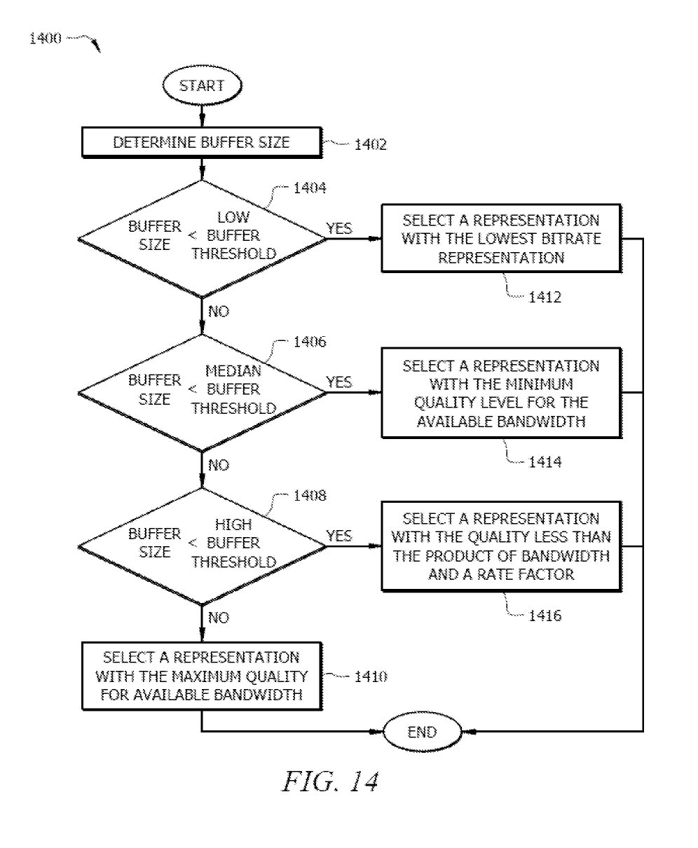

FIG. 14 is a flowchart of an embodiment of a representation adaptation method 1400 using timed metadata information. In an embodiment, the representation adaptation method 1400 may be implemented on a client (e.g., DASH client 108 as described in FIG. 1) to select representations for media content segments using quality information. For example, method 1400 may be implemented to select a media segment representation to request based on timed metadata information, such as, in step 316 described in FIG. 3. A buffer threshold may be set and/or adjusted to improve performance in various environments. For instance, one or more buffer thresholds may be set to reduce playback interruptions due to changing available bandwidth. For example, a lower buffer threshold may be about 20% of an available bandwidth, a median buffer threshold may be about 20% to about 80% of the available bandwidth, and a high buffer threshold may be about 80% of the available bandwidth.

At step 1402, method 1400 may determine the buffer size for a DASH client. At step 1404, method 1400 may determine if the buffer size is less than a lower buffer threshold. If the buffer size is less than the lower buffer threshold, then method 1400 may proceed to step 1412; otherwise, method 1400 may proceed to step 1406. At step 1412, method 1400 may select a representation that comprises the lowest bitrate and may terminate. Returning to step 1404, if the buffer size is not less than the lower buffer threshold, then method 1400 may proceed to step 1406. At step 1406, method 1400 may determine if the buffer size is less than a median buffer threshold. If the buffer size is less than the median buffer threshold, then method 1400 may proceed to step 1414; otherwise, method 1400 may proceed to step 1408. At step 1414, method 1400 may select a representation that comprises a minimum quality level for the available bandwidth and may terminate. Returning to step 1406, if the buffer size is not less than the median buffer threshold, then method 1400 may proceed to step 1408. At step 1408, method 1400 may determine if the buffer size is less than a high buffer threshold. If the buffer size is less than the high buffer threshold, then method 1400 may proceed to step 1416; otherwise, method 1400 may proceed to step 1410. At step 1416, method 1400 may select a representation that comprises a quality level that is less than a maximum bitrate of a representation that can be selected (e.g., the product of the available bandwidth and a rate factor) and may terminate. A rate factor may be used to adjust a maximum bitrate of a representation that can be selected relative to the available bandwidth. In an embodiment, the rate factor may be a value greater than one (e.g., about 1.2). Returning to step 1408, if the buffer size is not less than the high buffer threshold, then method 1400 may proceed to step 1410. At step 1410, method 1400 may select a representation that comprises a maximum quality level for the available bandwidth and may terminate.

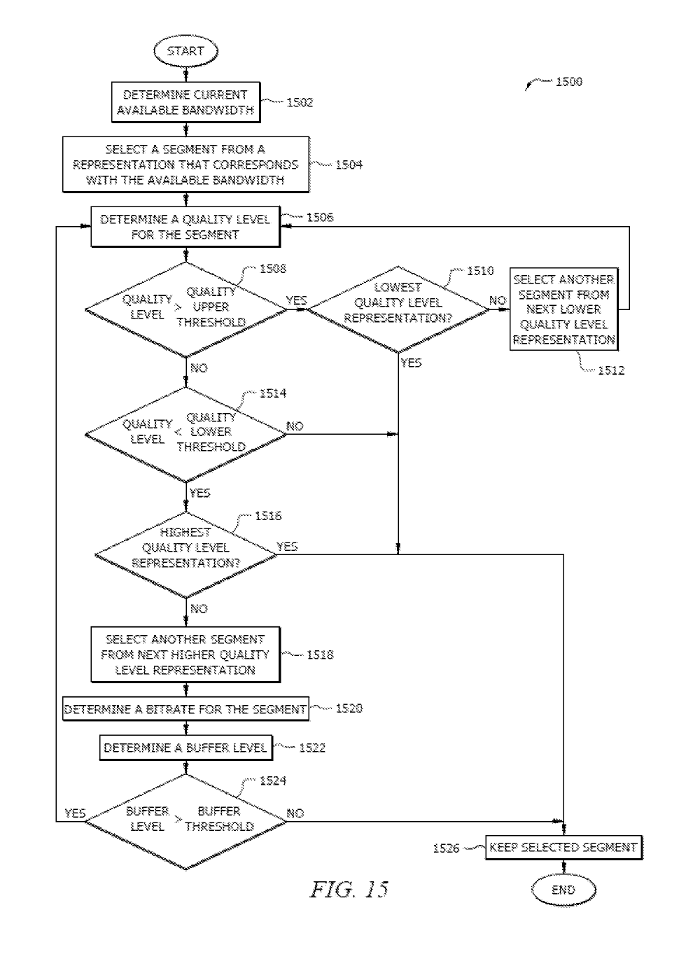

FIG. 15 is a flowchart of another embodiment of a representation adaptation method 1500 using timed metadata information. In an embodiment, the representation adaptation method 1500 may be implemented on a client (e.g., DASH client 108 as described in FIG. 1) to select representations for media content segments using quality information. For example, method 1500 may be implemented to select a media segment representation to request based on metadata information, such as, in step 316 described in FIG. 3. In an embodiment, a quality threshold may be determined based on the overall quality of historically downloaded segments and/or an acceptable range for quality change. Alternatively, a quality threshold may be determined according to an average available bandwidth. A quality upper threshold may be calculated as the overall quality plus one half of the range. A quality lower threshold may be calculated as the overall quality minus one half of the range.

At step 1502, method 1500 may determine a current available bandwidth. At step 1504, method 1500 may select a segment from a representation that corresponds with the available bandwidth. At step 1506, method 1500 may determine a quality level for the segment. At step 1508, method 1500 may determine if the quality level is greater than a quality upper threshold. If the quality level is greater than the quality upper threshold, then method 1500 may proceed to step 1510; otherwise, method 1500 may proceed to step 1514. At step 1510, method 1500 may determine if the current representation level is the lowest quality level representation. If the current representation is the lowest quality level representation, then method 1500 may proceed to step 1526; otherwise, method 1500 may proceed to step 1512. At step 1526, method 1500 may keep the selected segment and may terminate. Returning to step 1510, if the current representation level is not the lowest quality level, then method 1500 may proceed to step 1512. At step 1512, method 1500 may select another segment from the next lower quality level representation and may proceed to step 1506.

Returning to step 1508, if the quality level is not greater than the quality upper threshold, then method 1500 may proceed to step 1514. At step 1514, method 1500 may determine if the quality level is less than the quality lower threshold. If the quality level is less than the quality lower threshold, then method 1500 may proceed to step 1516; otherwise, method 1500 may proceed to step 1526. At step 1516, method 1500 may determine if the current representation level is the highest quality level representation. If the current representation level is the highest quality level representation, then method 1500 may proceed to step 1526; otherwise, method 1500 may proceed to step 1518. At step 1518, method 1500 may select another segment from the next higher quality level representation. At step 1520, method 1500 may determine a bitrate for the segment. At step 1522, method 1500 may determine a buffer level for a DASH client. At step 1524, method 1500 may determine if the buffer level is greater than a buffer threshold. If the buffer level is greater than the buffer threshold, then method 1500 may proceed to step 1506; otherwise, method 1500 may proceed to step 1526.

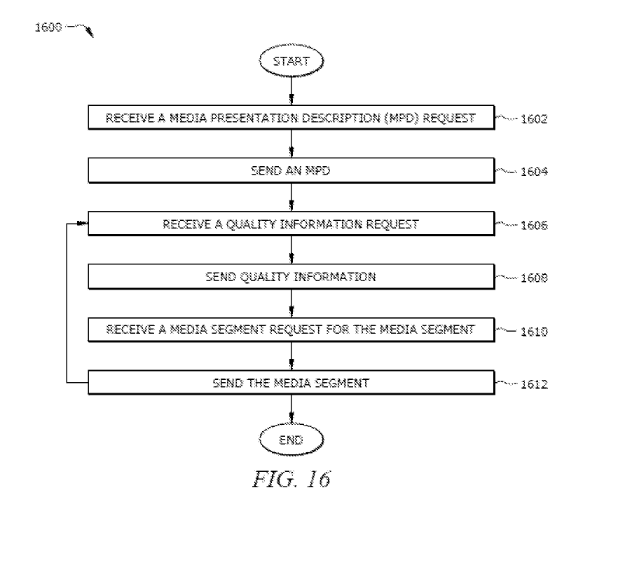

FIG. 16 is a flowchart of another embodiment of a representation adaptation method 1600. In an embodiment, the representation adaptation method 1600 may be implemented on a server (e.g., HTTP server 104 as described in FIG. 1) to communicate quality information and media content segments to one or more clients (e.g., DASH client 108 as described in FIG. 1). At step 1602, method 1600 may receive an MPD request for an MPD that comprises instructions for downloading or receiving segments of data content and metadata information. At step 1604, method 1600 may send the MPD. Steps 1602 and 1604 may be optional and may be omitted in other embodiments. At step 1606, method 1600 may receive a quality information request. At step 1608, method 1600 may send the quality information. At step 1610, method 1600 may receive a media segment request. At step 1612, method 1600 may send the requested media segment. Method 1600 may continue to receive and/or send quality information and/or media segments, similar to as previously discussed with respect to steps 1606-1612.

At least one embodiment is disclosed and variations, combinations, and/or modifications of the embodiment(s) and/or features of the embodiment(s) made by a person having ordinary skill in the art are within the scope of the disclosure. Alternative embodiments that result from combining, integrating, and/or omitting features of the embodiment(s) are also within the scope of the disclosure. Where numerical ranges or limitations are expressly stated, such express ranges or limitations should be understood to include iterative ranges or limitations of like magnitude falling within the expressly stated ranges or limitations (e.g., from about 1 to about 10 includes, 2, 3, 4, etc.; greater than 0.10 includes 0.11, 0.12, 0.13, etc.). For example, whenever a numerical range with a lower limit, Rₗ, and an upper limit, Rᵤ, is disclosed, any number falling within the range is specifically disclosed. In particular, the following numbers within the range are specifically disclosed: R=Rₗ+k*(Rᵤ−Rₗ), wherein k is a variable ranging from 1 percent to 100 percent with a 1 percent increment, i.e., k is 1 percent, 2 percent, 3 percent, 4 percent, 5 percent, . . . , 50 percent, 51 percent, 52 percent, . . . , 95 percent, 96 percent, 97 percent, 98 percent, 99 percent, or 100 percent. Moreover, any numerical range defined by two R numbers as defined in the above is also specifically disclosed. The use of the term “about” means ±10% of the subsequent number, unless otherwise stated. Use of the term “optionally” with respect to any element of a claim means that the element is required, or alternatively, the element is not required, both alternatives being within the scope of the claim. Use of broader terms such as comprises, includes, and having should be understood to provide support for narrower terms such as consisting of, consisting essentially of, and comprised substantially of. Accordingly, the scope of protection is not limited by the description set out above but is defined by the claims that follow, that scope including all equivalents of the subject matter of the claims. Each and every claim is incorporated as further disclosure into the specification and the claims are embodiment(s) of the present disclosure. The discussion of a reference in the disclosure is not an admission that it is prior art, especially any reference that has a publication date after the priority date of this application. The disclosure of all patents, patent applications, and publications cited in the disclosure are hereby incorporated by reference, to the extent that they provide exemplary, procedural, or other details supplementary to the disclosure.

While several embodiments have been provided in the present disclosure, it should be understood that the disclosed systems and methods might be embodied in many other specific forms without departing from the spirit or scope of the present disclosure. The present examples are to be considered as illustrative and not restrictive, and the intention is not to be limited to the details given herein. For example, the various elements or components may be combined or integrated in another system or certain features may be omitted, or not implemented.

In addition, techniques, systems, subsystems, and methods described and illustrated in the various embodiments as discrete or separate may be combined or integrated with other systems, modules, techniques, or methods without departing from the scope of the present disclosure. Other items shown or discussed as coupled or directly coupled or communicating with each other may be indirectly coupled or communicating through some interface, device, or intermediate component whether electrically, mechanically, or otherwise. Other examples of changes, substitutions, and alterations are ascertainable by one skilled in the art and could be made without departing from the spirit and scope disclosed herein.

What is claimed is:

1. A media representation adaptation method, comprising:
obtaining a media presentation description (MPD) that comprises information for retrieving a plurality of media segments and a plurality of metadata segments associated with the plurality of media segments, wherein the plurality of metadata segments comprises timed metadata information associated with the plurality of media segments;
sending a metadata segment request for one or more of the metadata segments in accordance with the information provided in the MPD;
receiving the one or more metadata segments;
selecting one or more media segments based on the timed metadata information of the one or more metadata segments;
sending a media segment request that requests the selected media segments; and
receiving the selected media segments in response to the media segment request.

2. The method of claim 1, wherein the one or more metadata segments have a one-to-one correspondence with the selected media segments.

3. The method of claim 1, wherein the timed metadata information comprises quality information associated with the plurality of media segments.

4. The method of claim 1, wherein each of the plurality of metadata segments comprises a movie fragment box, one or more track fragment boxes, one or more track run boxes, and a plurality of samples.

5. The method of claim 1, wherein each of the plurality of metadata segments comprises a plurality of samples with a one-to-one association with a plurality of samples in one of the plurality of media segments.

6. The method of claim 1, wherein each of the plurality of metadata segments comprises one or more track run boxes with a one-to-one association with one or more track run boxes in one of the plurality of media segments.

7. The method of claim 1, wherein each of the metadata segments comprises one or more track fragment boxes with a one-to-one association with one or more track fragment boxes in one of the plurality of media segments.

8. The method of claim 1, wherein each of the plurality of metadata segments comprises a movie fragment box with a one-to-one association with a movie fragment box in one of the plurality of media segments.

9. The method of claim 1, wherein each of the plurality of metadata segments comprises a movie fragment box associated with a plurality of movie fragment boxes in one of the plurality of media segments.

10. The method of claim 1, further comprising retrieving bitrate information associated with the plurality of media segments.

11. The method of claim 1, further comprising retrieving information about available network bandwidth.

12. The method of claim 1, wherein timed metadata information of the one or more metadata segments can be accessed independent of the media segments.

13. A computer program product comprising computer executable instructions stored on a non-transitory computer readable medium that when executed by a processor causes a network device to perform the following:
obtain a media presentation description (MPD) that comprises information for retrieving one or more segments from a plurality of adaptation sets;
send a first segment request for one or more segments from a first adaptation set in accordance with the information provided in the MPD, wherein the first adaptation set comprises timed metadata information associated with a plurality of segments in a second adaptation set;
receive the segment from the first adaptation set;
select one or more segments from the plurality of segments in the second adaptation set based on the one or more segments from the first adaptation set, wherein the one or more selected segments from the plurality of segments in the second adaptation set comprises media content;
send a second segment request that requests the one or more selected segments from the second adaptation set; and
receive the one or more selected segments from the second adaptation set in response to the second segment request.

14. The computer program product of claim 13, wherein the first adaptation set comprises a first plurality of representations, wherein the second adaptation set comprises a second plurality of representations, and wherein the first representations are mapped to one or more of the second representations.

15. The computer program product of claim 14, wherein the first representations and the second representations have a one-to-one correspondence.

16. The computer program product of claim 13, wherein the timed metadata comprises quality information associated with the plurality of segments in the second adaptation set.

17. The computer program product of claim 13, wherein the timed metadata comprises one or more metrics used to obtain the timed metadata information.

18. An apparatus for media representation adaptation according to a media presentation description (MPD) that comprises information for retrieving a plurality of media segments from a first adaptation set and a plurality of metadata segments from a second adaptation set, comprising:
a memory; and
a processor coupled to the memory, wherein the memory includes instructions that when executed by the processor cause the apparatus to perform the following:
send a metadata segment request in accordance with the MPD;
receive one or more metadata segments that comprises timed metadata information associated with one or more of the media segments;
select one or more media segments using the metadata information;
send a media segment request that requests the selected one or more media segments; and
receive the one or more media segment in accordance with the MPD.

19. The apparatus of claim 18, wherein each of the metadata segment has a one-to-one correspondence with one of the media segments.

20. The apparatus of claim 18, wherein the first adaptation set comprises a first plurality of representations, wherein the second adaptation set comprises a second plurality of representations, and wherein the second representations are mapped to one or more of the first representations.
